(19) United States
(12) Patent Application Publication
(10) Pub. No.: US 2020/0097790 A1
(43) Pub. Date: Mar. 26, 2020

(54) NAME TAG

(71) Applicant: KYOCERA Document Solutions Inc., Osaka (JP)

(72) Inventor: Masato SHIOSE, Osaka-shi (JP)

(73) Assignee: KYOCERA Document Solutions Inc., Osaka (JP)

(21) Appl. No.: 16/571,067

(22) Filed: Sep. 14, 2019

(30) Foreign Application Priority Data
Sep. 25, 2018 (JP) 2018-178945

(51) Int. Cl. G06K 19/077; G06K 7/10; G06K 19/07; G06F 9/445

(52) U.S. Cl. CPC G06K 19/07749; G06K 7/10297; G06F 9/445; G06K 19/0723; G06K 19/07703

(57) ABSTRACT

A name tag includes a display section, a communication section that communicates with a base device, and a controller. The controller switches an operation mode of the name tag from a normal mode that is an operation mode for non-emergency to an emergency mode that is an operation mode for emergency upon occurrence of disruption of communication with the base device. In the normal mode, the display section is controlled by the controller to display a name of a user. In the emergency mode, the display section is controlled by the controller to display emergency information including information indicating an evacuation center.

### INCORPORATION BY REFERENCE

The present application claims priority under 35 U.S.C. § 119 to Japanese Patent Application No. 2018-178945, filed on Sep. 25, 2018, the entire disclosure of which is incorporated herein by reference.

### BACKGROUND

The present disclosure relates to name tags.

A particular type of name tag includes a liquid crystal display section and a communication section. Such a name tag exchange data with an electronic device, such as an electronic cash register, time clock, personal computer, photocopier, and word processor.

### SUMMARY

A name tag according to the present disclosure includes a display section, a communication section that communicates with a base device, and a controller. The controller switches an operation mode of the name tag from a normal mode to an emergency mode upon occurrence of disruption of communication with the base device. The normal mode is an operation mode for non-emergency. The emergency mode is an operation mode for emergency. In the normal mode, the display section is controlled by the controller to display a name of a user. In the emergency mode, the display section is controlled by the controller to display emergency information including information indicating an evacuation center.

### BRIEF DESCRIPTION OF THE DRAWINGS

FIG. 1 is a diagram illustrating an example configuration of a name tag according to an embodiment.

FIG. 2 is a diagram illustrating an example display of a display section in a normal mode.

FIG. 3 is a diagram illustrating an example menu screen in an emergency mode.

FIG. 4 is a diagram illustrating an example display of personal information in the emergency mode.

FIG. 5 is a diagram illustrating another example display of the personal information in the emergency mode.

FIG. 6 is a diagram for describing name tag-to-name tag communication in the emergency mode.

FIG. 7 is a diagram for describing information center communication in the emergency mode.

FIG. 8 is a flowchart illustrating an example process performed by a controller.

### DETAILED DESCRIPTION

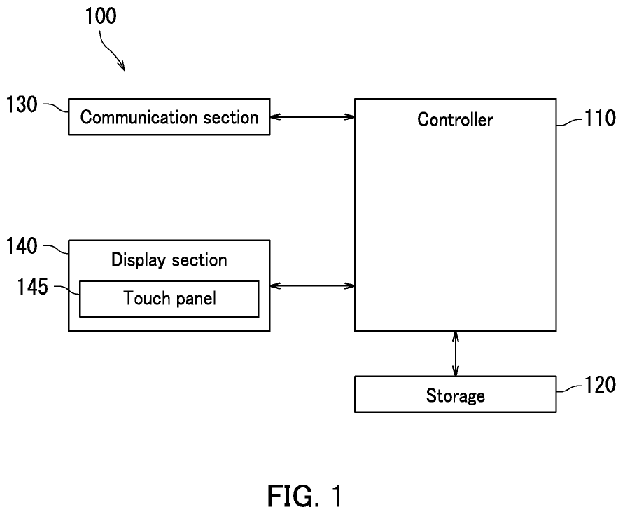

An embodiment of the present disclosure will now be specifically described with reference to the accompanying drawings (FIGS. 1 to 8). Note that the same or corresponding parts are designated by the same reference signs throughout the several views, and will not be redundantly described.

Firstly, a name tag 100 according to an embodiment will be described with reference to FIG. 1. FIG. 1 is a diagram illustrating an example configuration of the name tag 100 of this embodiment.

As illustrated in FIG. 1, the name tag 100 includes a controller 110, storage 120, a communication section 130, and a display section 140. The name tag 100 is driven by a battery (not illustrated).

The controller 110 includes a processor such as a central processing unit (CPU). The storage 120 includes a storage device that stores data and a computer program therein. The storage 120 includes a storage device such as rewritable non-volatile semiconductor memory. The processor of the controller 110 controls each element of configuration of the name tag 100 by executing the computer program stored in the storage device of the storage 120.

The communication section 130 communicates with a base device, name tags, and a server located at a specific information center. In the above configuration, the communication section 130 has, for example, a wireless local area network (LAN) function.

The display section 140 displays information for a user and receives user input. In the above configuration, the display section 140 includes, for example, electronic paper having a touch panel 145.

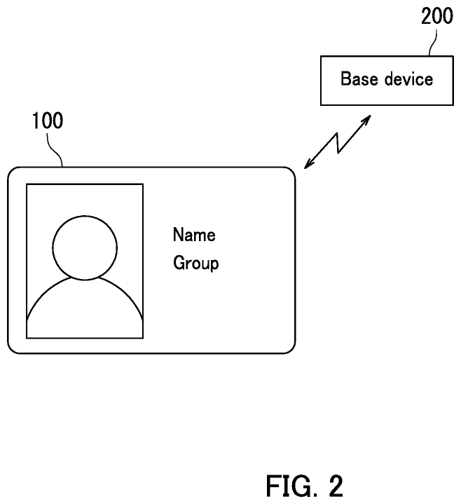

Next, operation of the name tag 100 in a normal mode will be described with reference to FIG. 2. FIG. 2 is a diagram illustrating an example display of the display section 140 in the normal mode.

As illustrated in FIG. 2, the display section 140 is controlled by the controller 110 to display an image, name, and group of the user in the normal mode which is an operation mode during non-emergency. The communication section 130 is also controlled by the controller 110 to communicate with a base device 200 at predetermined time intervals. Note that data for displays of the display section 140 is stored in the storage 120 in advance.

The controller 110, when communication with the base device 200 has been disrupted, switches the operation mode of the name tag 100 from the normal mode to an emergency mode which is an operation mode upon occurrence of a disaster event.

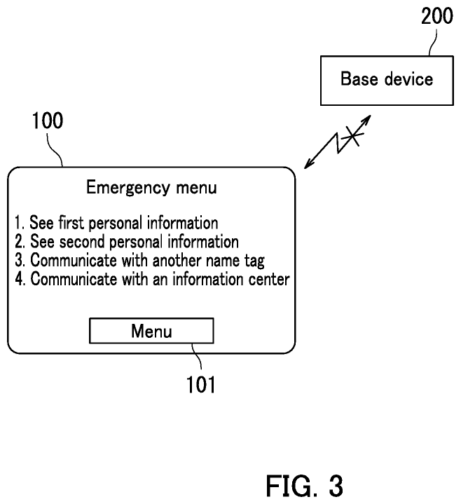

Next, an operation of the name tag 100 in the emergency mode will be described with reference to FIGS. 3 to 7. FIG. 3 is a diagram illustrating an example menu screen.

As illustrated in FIG. 3, the display section 140 is controlled by the controller 110 to display a screen of an emergency menu. The emergency menu contains menu items “See first personal information,” “See second personal information,” “Communicate with another name tag,” and “Communicate with an information center.” The emergency menu further contains a menu switch 101 (“Menu”). The menu switch 101 is for returning to the screen of the emergency menu of FIG. 3 from another screen in the emergency mode. The user selects one of the menu items, “See first personal information,” “See second personal information,” “Communicate with another name tag,” and “Communicate with an information center” by operating the touch panel 145.

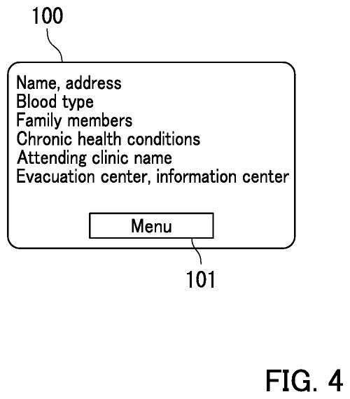

Next, an operation of the name tag 100 that is performed when the “See first personal information” menu item has been selected in the emergency menu will be described with reference to FIG. 4. FIG. 4 is a diagram illustrating an example display of the first personal information.

As illustrated in FIG. 4, the display section 140 is controlled by the controller 110 to display emergency information. The emergency information includes personal information indicating each of the user's name, address, blood type, family members, chronic health conditions, and attending clinic name, and an evacuation center or emergency shelter assigned to the user. The emergency information further includes information about an information center shared by a plurality of users. Note that data for displays of the display section 140 is stored in the storage 120 in advance.

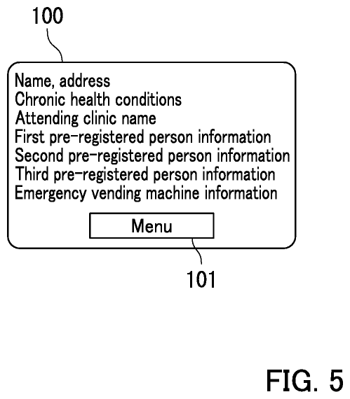

Next, an operation of the name tag 100 that is performed when the “See second personal information” menu item has been selected in the emergency menu will be described with reference to FIG. 5. FIG. 5 is a diagram illustrating an example display of second personal information.

As illustrated in FIG. 5, the display section 140 is controlled by the controller 110 to display emergency information. The emergency information includes personal information indicating each of the user's name, address, chronic health conditions, and attending clinic name, a first pre-registered person, a second pre-registered person, and a third pre-registered person. The first to third pre-registered persons each are a person who has been registered by the user in advance in order to obtain disaster welfare information. The emergency information further includes information about an emergency vending machine shared by a plurality of users. Note that data for displays of the display section 140 is stored in the storage 120 in advance.

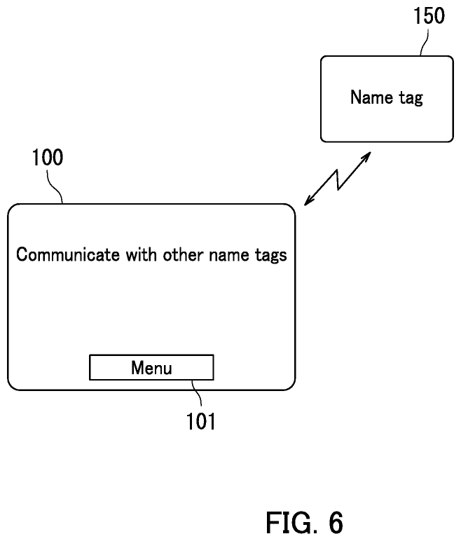

Next, an operation of the name tag 100 that is performed when the “Communicate with another name tag” menu item has been selected in the emergency menu will be described with reference to FIG. 6. FIG. 6 is a diagram for describing name tag-to-name tag communication.

As illustrated in FIG. 6, the communication section 130 is controlled by the controller 110 to communicate with a different name tag 150. The different name tag 150 is possessed by a user different from the user of the name tag 100. The communication section 130 is controlled by the controller 110 to obtain a name of the user of the different name tag 150 from the different name tag 150.

The user can use the name tag-to-name tag communication to obtain information of a person whom the user has met during evacuation to confirm the person's safety. Specifically, the name tag 100 has a message menu that allows the user to obtain another person's message such as “I am leaving for xx now” or “I will keep staying here yy.” In addition, the name tag 100 has a time stamp function that adds a time stamp to the other person's message. These pieces of information about the other person are stored in the storage 120.

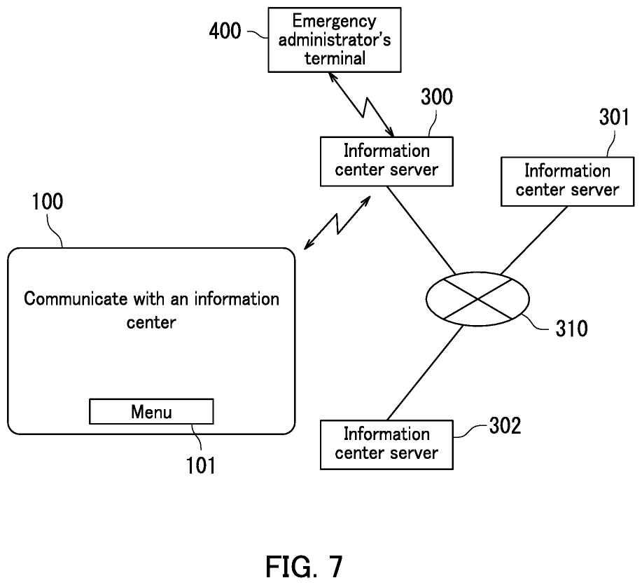

Next, an operation of the name tag 100 that is performed when the “Communicate with an information center” menu item has been selected in the emergency menu will be described with reference to FIG. 7. FIG. 7 is a diagram for describing information center communication.

As illustrated in FIG. 7, the communication section 130 has the function of communicating with the server at the specific information center. The information center refers to a place that is designated in advance for contact. The information center is preferably a place where power can be available by a stand-alone means even during emergency, such as an engine power generator, solar power generator, or battery. Examples of the information center include a hospital, city hall, convenience store, and park.

FIG. 7 shows an example in which there are three places each designated an information center. Specifically, a first information center server 300, a second information center server 301, and a third information center server 302 are installed in advance. The first to third information center servers 300 to 302 are connected together through the Internet 310.

The communication section 130 communicates with the first information center server 300 at an information center which the user visits. The first information center server 300 can write data to the name tag 100 and read data from the name tag 100. If important information particularly including evacuation center change has been updated, the first information center server 300 updates corresponding information in the storage 120. An emergency administrator's terminal 400 has authority to access the personal information of users in the first information center server 300.

The user can organize data stored in the storage 120 at an information center. For example, when the user has already arrived at an evacuation center, data of evacuation centers is no longer needed. Therefore, if there is other data having higher priority, the data of evacuation centers is deleted. As a result, the space shortage of the storage 120 can be avoided.

The communication section 130 is controlled by the controller 110 to transfer, to the first information center server 300, information indicating that the user has visited an information center. The communication section 130 is also controlled by the controller 110 to transfer, to the first information center server 300, information indicating that the user has met another user. These pieces of information are utilized as disaster welfare information.

The communication section 130 is controlled by the controller 110 to obtain, from the first information center server 300, disaster welfare information of a pre-registered person P. If the person P has left their own disaster welfare information in the second information center server 301, the first information center server 300 obtains the disaster welfare information of the person P from the second information center server 301 through the Internet 310. This allows the user of the name tag 100 to obtain the disaster welfare information of the pre-registered person P from the first information center server 300.

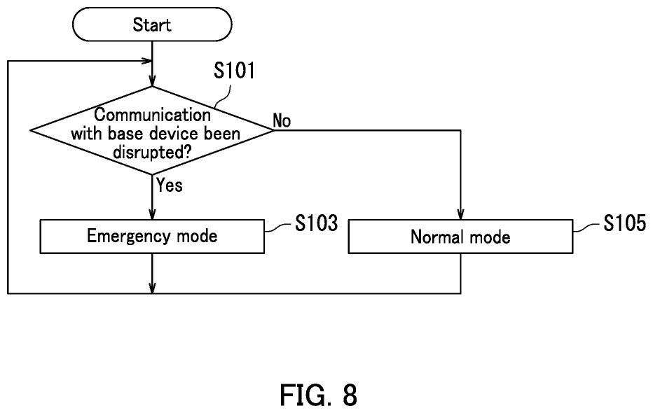

Next, a process performed by the controller 110 will be described with reference to FIG. 8. FIG. 8 is a flowchart illustrating an example of the process performed by the controller 110.

In Step S101, the controller 110 determines whether or not communication with the base device 200 has been disrupted. If the controller 110 determines that communication with the base device 200 has been disrupted (YES in Step S101), the process by the controller 110 proceeds to Step S103. If the controller 110 determines that communication with the base device 200 has not been disrupted (NO in Step S101), the process by the controller 110 proceeds to Step S105.

In Step S103, the controller 110 selects the emergency mode as the operation mode. Thereafter, the process by the controller 110 returns to Step S101.

In Step S105, the controller 110 selects the normal mode as the operation mode. Thereafter, the process by the controller 110 returns to Step S101.

In Steps S101 to S105, when communication with the base device 200 has been disrupted, the operation mode of the name tag 100 is switched from the normal mode to the emergency mode on the assumption that a disaster emergency has occurred. In the normal mode, the display section 140 is controlled by the controller 110 to display the user's name. In the emergency mode, the display section 140 is controlled by the controller 110 to display emergency information including information indicating an evacuation center.

Note that it is preferable that the first personal information of FIG. 4 should be involuntarily displayed immediately after the operation mode of the name tag 100 has been switched from the normal mode to the emergency mode. Information indicating an evacuation center is displayed immediately after occurrence of a disaster emergency, which is convenient for evacuation. In addition, personal information including a blood type is displayed, which is convenient for blood transfusion in a first aid. When the user presses down the menu switch 101 in the screen of FIG. 4, the screen of FIG. 4 is changed to the screen of the emergency menu of FIG. 3, through which the menu items can be selected.

According to the embodiment, even if infrastructures including the Internet 310 and a power system have been disrupted due to a disaster, the name tag 100 can display emergency information including information indicating an evacuation center. As a result, the name tag 100 can be used to take measures against a disaster emergency.

The embodiment described above is a preferred embodiment of the present disclosure, and therefore, various technically-preferred limitations may be placed on the embodiment. However, the technical scope of the present disclosure is not limited to the embodiment unless otherwise specified in the present disclosure. Specifically, the elements of configuration in the embodiment may be replaced as appropriate with existing elements of configuration or the like, and many variations including combinations with other existing elements of configuration can be made within the scope of the present disclosure. The disclosure of the embodiment does not limit the present disclosure as defined by the appended claims.

What is claimed is:

1. A name tag comprising:
a display section;
a communication section configured to communicate with a base device; and
a controller, wherein
the controller switches an operation mode of the name tag from a normal mode to an emergency mode upon occurrence of disruption of communication with the base device, the normal mode being an operation mode for non-emergency, the emergency mode being an operation mode for emergency, and
in the normal mode, the display section is controlled by the controller to display a name of a user,
in the emergency mode, the display section is controlled by the controller to display emergency information including information indicating an evacuation center.

2. The name tag according to claim 1, wherein
in the emergency mode, the display section is controlled by the controller to display personal information including information about an evacuation center assigned to the user.

3. The name tag according to claim 1, wherein
the communication section has a function of communicating with a different name tag possessed by another user different from the user, and
the communication section is controlled by the controller to obtain a name of the another user from the different name tag.

4. The name tag according to claim 1, wherein
the communication section has a function of communicating with a server at a specific information center, and
the communication section is controlled by the controller to transfer, to the server, information indicating that the user has visited the information center.

5. The name tag according to claim 1, wherein
the communication section has a function of communicating with a server at a specific information center, and
the communication section is controlled by the controller to obtain, from the server, disaster welfare information of a pre-registered person.

6. The name tag according to claim 3, wherein
the communication section further has a function of communicating with a server at a specific information center, and
the communication section is controlled by the controller to transfer, to the server, information indicating that the user has met the another user.
